(19) United States
(12) Patent Application Publication
(10) Pub. No.: US 2020/0271081 A1
(43) Pub. Date: Aug. 27, 2020

(54) MOTOR VEHICLE ENGINE START CONTROL EMPLOYING GEOFENCING

(71) Applicant: OCC TECHNOLOGIES, LLC, Lisle, IL (US)

(72) Inventors: Brian Mulshine, Saint Charles, IL (US); Sean Slyman, Geneva, IL (US)

(21) Appl. No.: 16/802,668

(22) Filed: Feb. 27, 2020

Related U.S. Application Data
(60) Provisional application No. 62/811,392, filed on Feb. 27, 2019.

(51) Int. Cl. F02N 11/08; G01C 21/28

(52) U.S. Cl. CPC F02N 11/0811; G01C 21/28; F02N 11/0807; F02N 2200/063; F02N 2200/023; F02N 2200/123; F02N 2200/0814; B60R 2325/10

(57) ABSTRACT

Remote starting of engines of motor vehicles in a fleet is allowed when the motor vehicles are within an area bounded by a geofence and certain mandatory vehicle-specific data parameters are satisfied, but is disallowed when any motor vehicle is outside the geofenced area or any of its mandatory vehicle-specific is non-compliant for engine starting.

### PRIORITY CLAIM

This non-provisional patent application claims priority of Provisional Patent Application No. 62/811,392, filed Feb. 27, 2019, and incorporates by reference the entire content of that prior application.

### TECHNICAL FIELD

The disclosed subject matter relates to systems for selectively allowing or disallowing a motor vehicle's engine to be started depending on the vehicle's location and on certain vehicle-specific data.

### BACKGROUND

Some vehicle storage yards have a size big enough for storing a large number of vehicles. One example is a school bus storage yard of a large school district. A fleet of school buses is commonly stored outdoors where they are exposed to ambient weather conditions. In cold weather, the engines of such buses must be warmed up before they can begin their assigned travel routes.

Warming up a school bus engine requires that upon arrival at a yard, a driver of a vehicle first obtain a key or keys for the vehicle from an office, then walk to the vehicle to unlock it, and then upon entering, start the engine. In very cold weather a driver may have to arrive at the yard earlier than in more temperate weather because a vehicle must leave the yard at a specified time, and its engine takes longer to warm up in the cold weather, especially when stored outdoors.

Garaging a fleet of buses overnight to avoid exposure to extreme cold weather requires a large capital investment which would not be cost-effective where extreme cold weather is infrequent. Moreover, warming up a fleet of vehicles inside a garage would pose a health hazard to personnel.

### SUMMARY

Remote starting of a fleet of school buses stored in a yard overnight would allow a few people (who may or may not include drivers), or even a single person, to start a much larger number of buses before most drivers arrive for duty. For example, in colder weather, a single fleet manager could remote start all buses which will be making runs before their drivers arrive for duty, thereby avoiding the necessity of having to call in the drivers earlier than they would normally arrive in more temperate weather. Communicating certain data about each bus to a fleet management system before or during engine starting, also allows a fleet manager to take early corrective action if any problems with a vehicle are encountered.

The disclosed subject matter relates generally to a system for selectively allowing and disallowing starting of an engine which propels a motor vehicle as a function of the location of the motor vehicle relative to a geofenced area.

More specifically, the system comprises: a geofence defining geographic co-ordinates data for an outdoor area; and a processing system, the processing system which is operable to process the geographic co-ordinates data for the outdoor area and other data, including geographic co-ordinates data for the location of the motor vehicle and certain vehicle-specific data, transmitted wirelessly from a motor vehicle, and to then either allow or disallow starting of an engine of the motor vehicle.

A disclosed embodiment relates to a remote start system for selectively allowing and disallowing remote starting an engine of a motor vehicle. A processing system processes geographic co-ordinates data for the outdoor area, geographic co-ordinates data for the location of the motor vehicle, and certain vehicle-specific data. The processing system is operable to allow the engine to be started by a wireless remote start command from a wireless device when the processing of the geographic co-ordinates data for the outdoor storage area and the geographic co-ordinates data for the location of the motor vehicle discloses that the motor vehicle is within the storage area and that certain mandatory vehicle-specific data is compliant with vehicle-specific data for allowing engine starting. The processing system is operable to disallow the engine from being remote started by a wireless remote start command when the processing of the geographic co-ordinates data for the outdoor storage area and the geographic co-ordinates data for location of the motor vehicle discloses that the motor vehicle is not within the storage area or any of the mandatory vehicle-specific data is non-compliant with the vehicle-specific data for allowing engine starting.

The foregoing summary is accompanied by further detail of the disclosure presented in the Detailed Description below with reference to the following drawings which are part of the disclosure.

### BRIEF DESCRIPTION OF THE DRAWINGS

FIG. 1 is perspective view, from the right front, of a portion of a motor vehicle, in particular a school bus vehicle.

FIG. 2 is a fragmentary top view of the school bus vehicle with portions broken way to reveal certain interior components.

FIG. 3 is a diagrammatic plan view of a parking facility for a vehicle fleet, including a service garage and a fleet management building.

FIG. 4 is a diagram of main elements of a remote start system in a vehicle.

FIGS. 5A and 5B collectively show a strategy diagram which is in part implemented in the diagram of FIG. 4.

FIG. 6 is a diagram of a fleet management portal which is in wireless communication with a vehicle.

### DETAILED DESCRIPTION

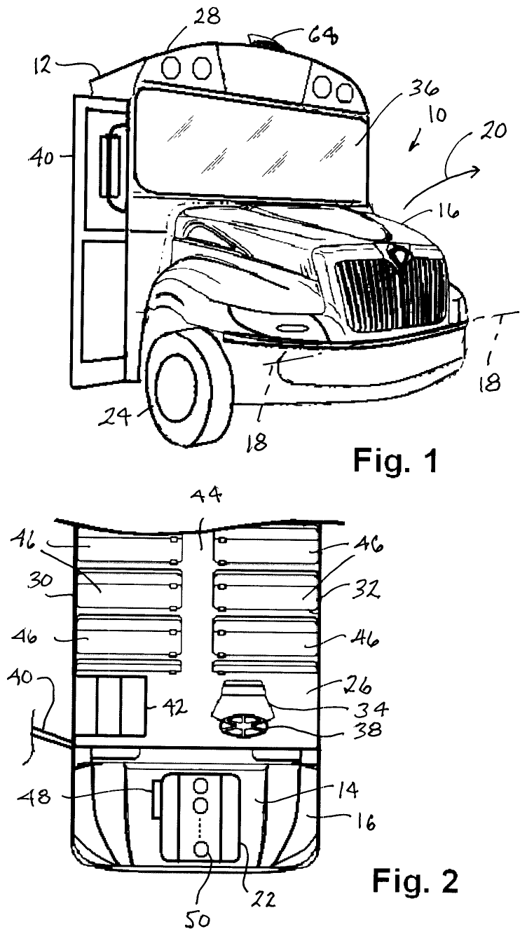

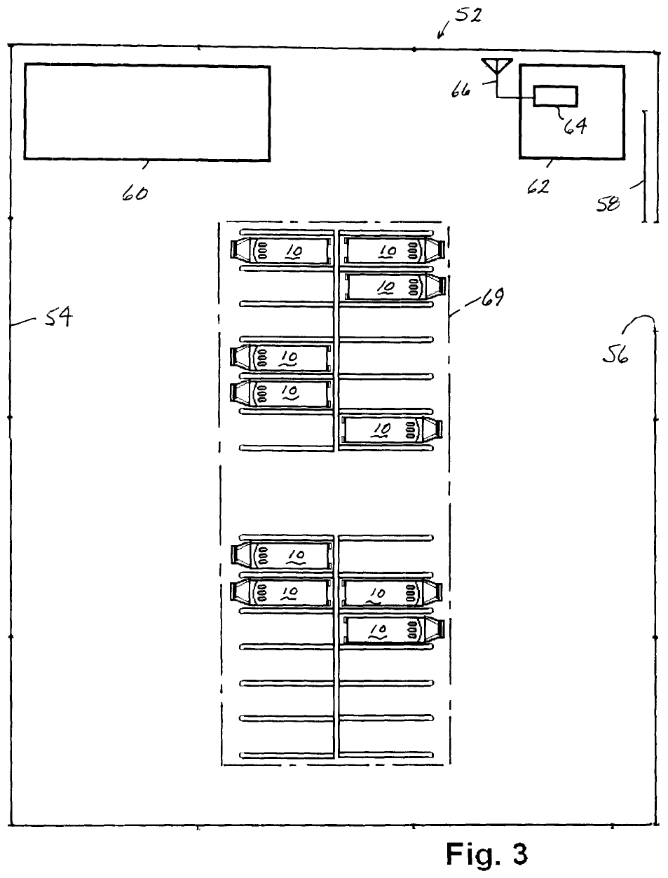

FIGS. 1 and 2 illustrate an example of one type of motor vehicle, a school bus vehicle 10 in this instance, which may be part of a fleet of identical, or at least similar, vehicles, i.e. a fleet of school buses in this example. School bus vehicle 10 has an underlying chassis having a chassis frame on which is mounted a multi-passenger bus body 12 which extends rearward from an engine compartment 14 at a front of the chassis frame. Engine compartment 14 is closed by a hood 16, as shown in FIG. 1, but when swung upwardly and forwardly about a horizontal hinge axis 18 as suggested by arrow 20, the hood opens to provide access to the engine compartment.

A fuel-consuming combustion engine 22 is mounted on a forward portion of the chassis frame in engine compartment 14. Engine 22 may be either a gasoline, i.e. spark-ignited, multi-cylinder engine or a diesel, i.e. compression ignition, multi-cylinder engine. Engine 22 operates through a drivetrain of a powertrain to drive rear wheels (not shown in the Figs.) which propel school bus vehicle 10 on an underlying surface. FIG. 1 shows one of two front steered wheels 24. Body 12 comprises a floor 26, a roof 28, right and left side walls 30, 32, and a rear wall (not shown in the Figs.) which collectively bound an interior occupant space for passengers and a driver. The rear wall contains an emergency exit having a door which can be opened in event of an emergency. Mounted on floor 26 at the left front of body 12 is a driver's seat 34. A windshield 36 provides the driver, and other occupants, a view of the outside in front of the bus vehicle.

Various controls, such as a steering wheel 38 for steering wheels 24, are accessible to a driver for operating the bus vehicle. At the front of right side wall 30 is a door 40 which provides ingress to and egress from the interior of the body. Opening and closing of door 40 is typically controlled by one of the controls accessible to a driver. Floor 26 is elevated high enough above ground level to require a stairway 42 of several steps for convenient ingress and egress. Floor 26 has a center aisle 44 and passenger seats 46 arranged in a succession of pairs of right and left seats in tandem on right and left sides of aisle 44.

Driver controls include a switch (commonly called an ignition switch) for starting and stopping engine 22. The switch, when operated to start the engine, provides an input to the vehicle's electrical system for initiating and controlling various steps of an engine starting procedure. The principal steps are engine cranking and engine fueling. Engine cranking is performed by operation of an electric cranking motor 48 (FIG. 2), and engine fueling is performed, typically by operating electric-actuated fuel injectors at engine cylinders 50 (FIG. 2).

Certain vehicles have the capability of being remotely started by wireless signals from a remote start controller. An example of a typical remote start controller is a key fob which not only has a metal key which can be inserted into a mechanical ignition switch in a vehicle to mechanically operate the ignition switch, but also has a wireless transmitter whose signal, when recognized by the vehicle's electrical system, enables a push button switch in the vehicle to start the engine via an engine control module (ECM). The fob has a door lock push button switch for wirelessly commanding locking of any vehicle doors not already locked. That all doors are locked is confirmed by visual, and/or audible, and/or other types of signals from the vehicle. The fob also has an engine start push button switch for wirelessly commanding engine starting. Once the engine has started running under its own power, the ECM discontinues operation of cranking motor 48 while fuel injectors continue to inject fuel into the engine cylinders 50 to operate engine 22 at idle and begin warming the engine.

If, during engine idling before the engine has fully warmed to operating temperature, a door, such as door 40, is unlocked by someone wanting to enter the vehicle, the engine will continue to run. However, the ignition switch will be in its off position. Assuming that certain conditions are satisfied, such as the vehicle brake pedal being depressed, and the transmission not being in a drive gear (being in Park for example), turning the ignition switch on, either by pushing a push button start switch when the key fob is present inside the vehicle, or by turning a key inserted into the ignition switch will keep the engine running until the ignition switch is turned off

However, if all doors remain locked for a length of time set by an engine run timer, the engine run timer will cause the engine to shut off upon elapse of a set run time. The set run time may be long enough to allow the engine to reach operating temperature during certain warmer outside temperatures, but not during certain relatively colder outside temperatures. If engine temperature reaches operating temperature without the run timer shutting the engine off, an engine temperature sensor, if used for control, will cause the running engine to be shut off upon engine temperature reaching operating temperature.

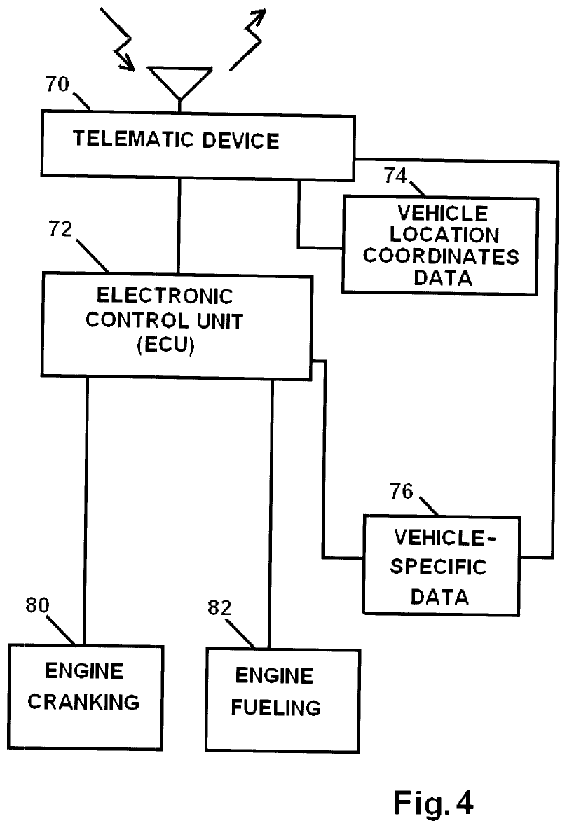

FIG. 3 portrays a storage yard 52 for a fleet of vehicles like school bus vehicle 10. Storage yard 52 is enclosed by a fence 54, except at an entrance/exit opening 56 which is opened and closed by a movable gate 58. FIG. 3 shows gate 58 open to allow vehicles to enter and exit the storage yard. Also located within the storage yard are a service garage 60 and a fleet management building 62.

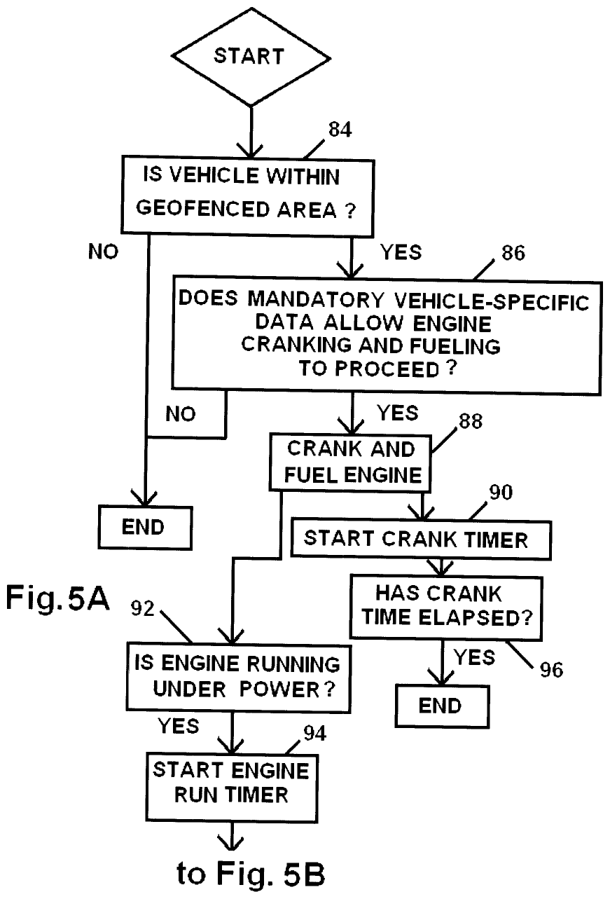

Building 62 houses a management center which may include a portal 64 for wirelessly communicating with vehicles in the fleet whether or not they are inside storage yard 52, such communication being via an antenna 66 on the exterior of building 62 which can transmit to and receive from an antenna 68 on a vehicle's roof, shown in FIG. 1. Wireless communication can also take place between the portal and a telematic device 70 (FIG. 4) in a vehicle. Wireless communications may employ cellular and/or Wi-Fi technology.

A geofence defines a virtual perimeter for a real-world geographic area using information obtained from the Global Positioning System (GPS). A geofence can have virtually any geometric shape. While the physical perimeter of storage yard 52 is bounded by fence 54 (an example of a rectangular shape), a geofence may coincide with fence 54 or bound only a limited area of the storage yard. In the example of FIG. 3, only the vehicle parking area is enclosed by a geofence 69. Geographic co-ordinate data, i.e. longitude, latitude, and elevation, for locations within the geofenced area can be developed by an algorithm which processes signals from satellites of the Global Positioning System and is then electronically stored, as will be more fully explained later.

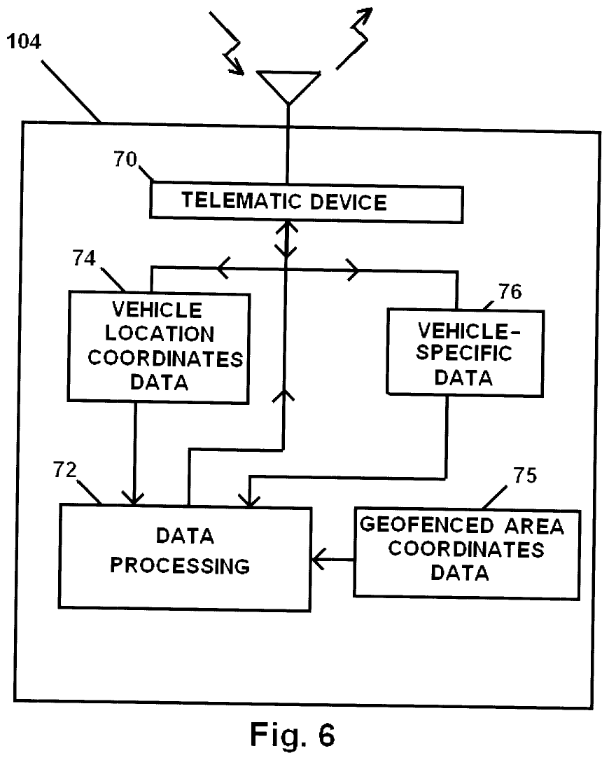

FIG. 4 shows main elements of a remote start system for starting engines of vehicles in a fleet, such as engine 22 of vehicle 10. One element in the vehicle is a telematic device 70 through which wireless data is received and transmitted. The vehicle has an electronic control unit (ECU) 72 which may include one or more electronic modules containing processors for processing data. Telematic device 70 and ECU 72 can communicate with each other. Geographic co-ordinates data 74 for the location of the vehicle is developed by telematic device 70 from signals received from satellites of the Global Positioning System, and that data 74 can be wirelessly transmitted from telematics device 70. While geographic co-ordinates data for geofence 69 could be electronically stored in ECU 72, that data (75 in FIG. 6) is preferably electronically stored at a remote data processing location, as will be more fully explained hereinafter. Vehicle-specific data 76 provided by switches, sensors, data buses, etc. in the vehicle is available in ECU 72, and is wirelessly transmitted by telematic device 70 to the remote data processing location.

When A) mandatory vehicle-specific data is processed and the result discloses that such data is compliant with data for allowing engine starting, and B) when the processing of geographic co-ordinates data 72 for the location of the vehicle and geographic co-ordinates data for the area enclosed by geofence 69 discloses that the vehicle is within the geofenced area, remote starting of engine 22 is allowed. Engine starting is initiated by wireless transmission of a remote start command to telematic device 70 which in turn initiates an engine start algorithm in ECU 72 for initiating engine cranking 80 and engine fueling 82 by an engine control module (ECM), one of the vehicle's processors.

While processing of the vehicle location data 74 and the data for the area enclosed by geofence 69 could be performed by ECU 72, that data is preferably processed at the remote location where the data for the area enclosed by the geofence is stored.

Processing of mandatory vehicle-specific data 76 could be performed by ECU 72 if data for distinguishing compliance from non-compliance is stored in ECU 72. However, that data is preferably transmitted to the remote location where the geofence data is stored.

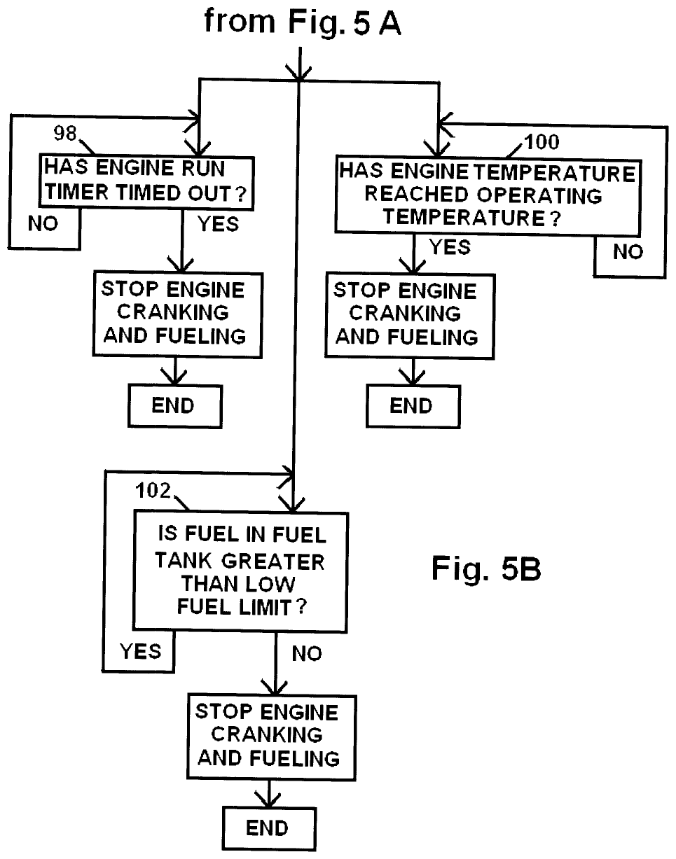

FIG. 5A and 5B collectively disclose an example of a remote start strategy some of which involves a vehicle and some of which involves the remote processing facility. An algorithm begins by determining if a vehicle is within the geofenced area (step 84). If it is not, execution of the algorithm ends.

However, if the algorithm determines that the vehicle is within the geofenced area, it then determines if data for all mandatory vehicle-specific conditions is satisfied for allowing engine cranking and fueling to proceed (step 86). If all such conditions are satisfied, engine 22 is cranked and fueled (step 88) and a start crank timer is started (step 90). Provided that the crank timer has not timed out, cranking and fuel continue until a step 92 discloses that the engine is running under its own power at which time an engine run timer is started (step 94). However, if the crank timer times out before the engine is running under its own power (step 96), further execution of the algorithm ends, aborting the starting process.

As shown in FIG. 5B, there are three independent conditions, any one of which, if the engine is running, will terminate engine running. Those conditions are 1) engine run timer times out (condition 98); 2) engine temperature has warmed to operating temperature (condition 100); and total quantity of fuel remaining in one or more fuel tanks is below a low fuel limit (condition 102). The low fuel limit may be set to assure a minimum supply for enabling the vehicle to be driven from its present location, such as from the outdoors to a garage in event of extreme weather conditions.

Examples of mandatory vehicle-specific data which must be satisfied for allowing engine cranking and fueling to proceed to steps 80 and 82 (FIG. 4) include: engine 22 not already running; the vehicle transmission not being in a drive gear; hood 16 not being latched closed; and vehicle cranking battery voltage being at least as great as rated voltage. Appropriate sensors, switches, data buses, etc. can provide such information, as mentioned earlier. A vehicle may also have a control switch (either electronic or mechanical) for enabling and disabling remote starting, and that switch must be in remote start enabling position to allow the strategy of FIGS. 5A and 5B to execute.

FIG. 6 discloses the basic elements of a fleet management portal 104 which has wireless communication with all vehicles in a fleet. Portal 104 is typically located remotely from the vehicles, such as at fleet management building 62, but it could be embodied in a portable device having wireless communication with the vehicles. Portal 104 would typically be under the control of a fleet manager.

Telematic device 70 has the capability to send, receive, and store wireless data, cellular and/or Wi-Fi. It collects GPS data as well as vehicle-specific data and transmits it to a server. An example of a server is commonly referred to as “The Cloud” which is located remotely from the portal. Data from a vehicle can be transmitted directly to “The Cloud” where the data is processed after which the result is transmitted to the portal, where the result may be visually displayed to the manager. Once remote starting of a vehicle has been allowed, the manager can transmit a wireless engine start command to the vehicle.

Geofence data and the processing system can be used in a different way to selectively lock an engine starting system in a motor vehicle and thereby prevent engine starting after the engine has been shut off, for example, after a vehicle has returned to the storage yard and is parked at a location within the geofence.

There are several possibilities for locking an engine starting system.

When the processing of the geofence data, of the geographic co-ordinates data for the location of the motor vehicle, and of other data discloses that the motor vehicle is within the outdoor area and the engine is not running, a control which is accessible only to authorized personnel can selectively lock and unlock an engine starting system to respectively prevent and allow engine starting.

One way of locking the engine starting system is to disable the ignition switch inside the vehicle, such as by preventing it from delivering voltage to the engine starting system. Even if a person has a key for entering a locked vehicle and attempts to use the key to operate the ignition switch, the disabled switch cannot activate the engine starting system. When the control unlocks the engine starting system, the ignition switch is again able to start the engine.

Another way of locking the engine starting system is to disable the engine cranking motor by blocking flow of electric current to it. When the control unlocks the engine starting system, current is allowed to flow to the cranking motor once again when the ignition switch is operated to crank the engine.

Both of these ways may be used concurrently, and each one can be used separately by itself. Locking the engine starting system can be considered as an anti-theft feature of the system which has already been described here, but it is also capable of independent use by itself. Even if an attempt were successfully made to “hot-wire” the ignition switch, locking the cranking motor would still prevent engine starting.

What is claimed is:

1. A system for selectively allowing and disallowing starting of an engine which propels a motor vehicle, the system comprising:
geofence data defining geographic co-ordinates data for an outdoor area; and
a processing system for processing data, the processing system being operable to process the geofence data, geographic co-ordinate data for the location of a motor vehicle, and mandatory vehicle-specific data for the motor vehicle and allow starting of an engine of the motor vehicle when A) the processing of the geofence data and the geographic co-ordinates data for the location of the motor vehicle discloses that the motor vehicle is within the outdoor area and B) the processing of the mandatory vehicle-specific data for the motor vehicle discloses that the mandatory vehicle-specific data is compliant with allowing engine starting, and the processing system being operable to disallow starting of the engine when C) the processing of the geofence data and the geographic co-ordinates data for the location of the motor vehicle discloses that the motor vehicle is not within the outdoor area or D) the processing of the mandatory vehicle-specific data for the motor vehicle discloses that any mandatory vehicle-specific data is non-compliant with allowing engine starting.

2. The system as set forth in claim 1 in which the processing system is operable to disable an ignition switch in the vehicle from starting the engine when the engine is not running.

3. The system as set forth in claim 1 in which the processing system is operable to disable an engine cranking motor from cranking the engine when the engine is not running.

4. The system as set forth in claim 1 in which the processing system enables an engine start command to be given to an engine starting strategy in the motor vehicle when engine starting is allowed.

5. The system as set forth in claim 1 in which the processing system is in wireless communication with a telematic device in the motor vehicle for E) wireless transmission of the vehicle's location and mandatory vehicle-specific data to the processing system and F) wireless transmission of an engine start command to the telematic device for remote starting of the engine.

6. The system as set forth in claim 1 including an ECU for detecting the engine having been started and running under its own power, and a timer for measuring engine running time.

7. The system as set forth in claim 6 in which the ECU is operable to shut off the engine after a preset engine running time has elapsed.

8. The system as set forth in claim 6 including an engine temperature sensor, and in which the ECU is operable to shut off the engine after the engine has reached a preset engine operating temperature.

9. The system as set forth in claim 6 including one or more fuel sensors for measuring quantity of fuel in one or more vehicle fuel tanks and an ECU for shutting off the engine when total fuel remaining in one or more fuel tanks is below a low fuel limit.

10. The system as set forth in claim 5 in which the motor vehicle has an engine cranking motor which starts upon receipt of an engine start command and a crank timer for measuring engine cranking time.

11. The system as set forth in claim 10 in which the ECU is operable to discontinue operation of the engine cranking motor after a preset engine cranking time has elapsed.

12. The system as set forth in claim 5 in which the mandatory vehicle-specific data comprises one or more of: the engine not running; a hood of an engine compartment of the vehicle being latched closed; a transmission in a drivetrain of the vehicle not being in a drive gear; and vehicle battery voltage for engine cranking being at least as great as rated battery voltage.

13. The system as set forth in claim 5 in which the vehicle has a switch for enabling and disabling remote starting, and the mandatory vehicle-specific data further comprises data disclosing that remote starting is enabled.

14. The system as set forth in claim 1 in which the engine has an engine starting system for cranking and fueling the engine, and further comprises a control for selectively locking the engine starting system to prevent engine starting after the engine has been shut off and processing of the geofence data and the geographic co-ordinates data for the location of the motor vehicle discloses that the motor vehicle is within the outdoor area.

15. The system as set forth in claim 14 in which an ignition switch in the vehicle is disabled when the control is locking the engine starting system.

16. The system as set forth in claim 14 in which an engine cranking motor which starts upon receipt of an engine start command is disabled by the control locking the engine starting system.

17. A system for selectively locking an engine starting system of an engine in a motor vehicle to prevent engine starting after the engine has been shut off, the system comprising:
geofence data defining geographic co-ordinates data for an outdoor area; and
a processing system for processing data, the processing system being operable to process the geofence data and geographic co-ordinate data for the location of a motor vehicle, and when the processing of the geofence data, the geographic co-ordinates data for the location of the motor vehicle, and other data discloses that the motor vehicle is within the outdoor area and the engine is not running, enables a control to selectively lock an engine starting system to disallow engine starting and unlocking the engine starting system to allow engine starting.

18. The system as set forth in claim 17 in which an ignition switch in the vehicle is disabled when the control is locking the engine.

19. The system as set forth in claim 17 in which an engine cranking motor which starts upon receipt of an engine start command is disabled when the control is locking the engine.
